(19) United States
(12) Patent Application Publication
(10) Pub. No.: US 2013/0058397 A1
(43) Pub. Date: Mar. 7, 2013

(54) APPARATUS AND METHOD FOR CONSTRUCTING AND INDEXING A REFERENCE IMAGE

(71) Applicants: Jinhan Song, Seoul (KR); Jeongyeon Lim, Gyeonggi-do (KR); Jongki Han, Seoul (KR); Yunglyul Lee, Seoul (KR); Joohee Moon, Seoul (KR); Haekwang Kim, Seoul (KR); Byeungwoo Jeon, Gyeonggi-do (KR); Myoung Hun Jang, Seoul (KR); Hyoungmee Park, Seoul (KR)

(72) Inventors: Jinhan Song, Seoul (KR); Jeongyeon Lim, Gyeonggi-do (KR); Jongki Han, Seoul (KR); Yunglyul Lee, Seoul (KR); Joohee Moon, Seoul (KR); Haekwang Kim, Seoul (KR); Byeungwoo Jeon, Gyeonggi-do (KR); Myoung Hun Jang, Seoul (KR); Hyoungmee Park, Seoul (KR)

(73) Assignee: SK Telecom Co., Ltd., Seoul (KR)

(21) Appl. No.: 13/698,538

(22) PCT Filed: May 17, 2011
(86) PCT No.: PCT/KR2011/003628

§ 371 Date: Nov. 21, 2012

(51) Int. Cl. H04N 11/02

(52) U.S. Cl. 375/240.02; 375/240.27; 375/240.12; 375/E07.243; 375/E07.126

(57) ABSTRACT

An apparatus for configuring and indexing a reference image for estimating motion vector includes: a reference image configuring unit for processing the reference image in a variety of arbitrary different methods and arranging reference frames according to processing methods; and an index assignment unit for assigning reference frame indexes according to the method processed by the reference image configuring unit.

### TECHNICAL FIELD

The present disclosure in one or more embodiments relates to an apparatus and method for configuring and indexing a reference image. More particularly, the present disclosure relates to an apparatus and method for configuring and indexing a reference image which may be interpolated in a variety of spatial resolutions or include such reference image as processed through illumination compensation, zoom-in and zoom-out, warping and the like so as to assign the index of reference frame according to the temporal position of the reference image.

### BACKGROUND

The statements in this section merely provide background information related to the present disclosure and may not constitute prior art.

During inter coding, the existing video codec, such as JM or KTA, estimates motion vector by using multiple previous frames or multiple future frames. With such use of several sheets of reference images, it is more likely that blocks similar to a current block will be found, and motion can be accurately estimated when a scene is changed or a hidden object pops up.

FIG. 1 shows advantage of when multiple reference images are used. When a sheet of an immediately previous image is used as a reference image, although a current sheet presents a mark ‘19’ on a uniform of a player who has a ball, the immediately previous reference image lacks the mark ‘19’. In this case, since it is difficult to find motion vector (MV), coding efficiency is lowered. However, if one sought a reference image further backward in time of an immediately previous sheet, the mark “19” could be found. This allows an accurate motion vector to be found when coding a current sheet.

In this manner, when motion vector is estimated by using multiple reference images, it is necessary to encode reference frame index indicating a reference image whenever blocks are coded. Currently, JM software utilizes a unary coding method to code index information of a reference image. The unary coding method is shown FIG. 2 and Table 1 below.

TABLE 1

| Reference frame index | Codeword |
|---|---|
| 1 | 1 |
| 2 | 01 |
| 3 | 001 |
| 4 | 0001 |
| 5 | 00001 |
| . | . |
| . | . |
| . | . |

Generally, an image temporally closest to a current frame is most similar to the current frame. Therefore, reference frame index generally assigns a shorter codeword to reference frame closer to the current frame, based on temporal order, and assigns a longer codeword to reference frame temporally farther from the current frame. Such a method may be used for bi-directional prediction as shown in FIG. 3 and Table 2 below.

TABLE 2

| | | | Reference | |
|---|---|---|---|---|
| Forward | Backward | + | frame index | Codeword |
| 0 | 1 | | 1 | 1 |
| | | | 2 | 01 |
| | | | 3 | 001 |
| | | | 4 | 0001 |
| | | | 5 | 00001 |
| | | | . | . |
| | | | . | . |
| | | | . | . |

Meanwhile, the process of encoding motion vector estimated in video codec is as follows. A predicted motion vector (PMV) made from peripheral blocks of current block is first calculated, and a calculation is then performed on a differential vector between the PMV and the motion vector found with respect to the current block. The difference vector is encoded into variable length codeword arranged by the integer multiple of motion vector resolution considered in the codec.

The JM software, which is the existing video codec, estimates motion vector in integer pixel unit, half (½) pixel unit, and quarter (¼) pixel unit, and compresses signals by motion vector having resolution of the highest compression efficiency. Meanwhile, in order to estimate motion vector more accurately, the KTA software finds a more accurate motion by estimating motion vector from integer pixel unit down to ⅛ pixel unit. However, in the KTA codec, it is necessary to perform encoding in consideration of motion vectors of all resolutions, such as integer pixel unit, ½ pixel unit, ¼ pixel unit, and ⅛ pixel unit. Therefore, a long codeword needs to be used even when a small motion vector is encoded. This increases the amount of bits generated, resulting in degradation in compression efficiency. Specific examples of these problems will be described below.

Table 3 below shows examples of codewords assigned to differential motion vectors in the codec considering pixel units from integer pixel unit to ¼ pixel unit.

TABLE 3

| Differential Motion Vector | Code Number | Bit String |
|---|---|---|
| 0 | 0 | 0 |
| 1/4 | 1 | 010 |
| −1/4 | 2 | 011 |
| 2/4 | 3 | 00101 |
| −2/4 | 4 | 00110 |
| . . . | . . . | . . . |
| 2 | 15 | 000010000 |
| . . . | . . . | . . . |
| 3 | 23 | 000011000 |
| . . . | . . . | . . . |

As can be seen from Table 3 above, if motion vectors of different resolutions are encoded in the typical compression standard, long codewords are also used for encoding small motion vectors. Consequently, the size of data generated in the process of encoding motion vectors is increased, which lowers compression efficiency. For example, when the differential motion vector is 3 and 2 in Table 3 above, a bit string ‘000011000’, whose code number is ‘23’, is used for encoding ‘3’, and a bit string ‘000010000’, whose code number is ‘15’, is used for encoding ‘2’. In this manner, long codewords are used for encoding small motion vectors because of using codewords for encoding motion vectors of ½ and ¼ pixel units along with codewords for encoding all motion vectors of integer pixel unit considered.

### DISCLOSURE

### Technical Problem

As described above, estimation of motion vectors of high resolutions is advantageous to find reference blocks which have very high correlation with current coding block. However, the compression efficiency may be lowered by the use of variable length codewords considering all resolution vectors from low-resolution motion vector values to high-resolution vector values. For example, in the case where most internal blocks of specific frame can be encoded by using only motion vectors of integer pixel unit or ½ pixel unit, if variable length codebook considering all resolutions from integer pixel unit to ⅛ pixel unit is used, variable length codewords of frequently used integer pixel and ½ pixel code vectors are lengthened by codewords considering unused ¼ pixels and ⅛ pixels. Consequently, the compression efficiency may be lowered. In this case, motion vectors of all resolutions are not required in some frames or some coding blocks, and only several specific types of resolution vectors may be used to have the encoding done efficiently.

On the contrary, the compression efficiency may be increased when using variable length codewords considering motion vectors of all resolutions from integer pixel unit to ⅛ pixel unit due to characteristics of internal pixel values in specific frame and block.

As another example, the compression efficiency may be increased when using a variable length codebook considering only several specific resolutions (for example, ½ pixel unit, ⅛ pixel unit) due to characteristics of internal pixel values in specific frame and block. In this case, the compression efficiency may be increased when the variable length codebook does not support codewords for motion vectors of integer pixel unit and ¼ pixel unit.

In order to solve the compression rate reduction problem related to resolutions of motion vectors, embodiments of the present disclosure are directed to provide an apparatus and method for configuring and indexing a reference image, in which a reference image is interpolated in different spatial resolutions, such that the reference image can be used as reference images having different reference frame indexes. In the apparatus and method for configuring and indexing the reference image according to one or more embodiments of the present disclosure, there is no limitation to interpolation methods or motion estimation methods.

In addition, reference images may be configured based on differentiated spatial resolutions by respective images. However, embodiments of the present disclosure are directed to providing an apparatus and method for configuring and indexing reference images which can use variously configured reference images, such as illumination compensated reference images, zoomed-in and zoomed-out reference images, warped reference images and the like.

### SUMMARY

According to a first embodiment of the present disclosure, an apparatus for configuring and indexing a reference image for estimating motion vector includes: a reference image configuring unit for processing the reference image in a variety of arbitrary different methods and arranging reference frames according to processing methods; and an index assignment unit for assigning reference frame indexes according to the method processed by the reference image configuring unit.

The reference frame may be one or more of non-interpolated frame, ½ pixel unit frame, ¼ pixel unit frame, ⅛ pixel unit frame, and frame combined with two or more of ½ pixel unit, ¼ pixel unit, and ⅛ pixel unit.

When motion vector estimated in the reference frame is encoded, the motion vector may be encoded by using different codebooks according to the spatial resolution of the reference frame.

According to a second embodiment of the present disclosure, an apparatus for configuring and indexing a reference image for estimating motion vector includes: a reference image configuring unit for zooming the reference image in a variety of ratios and arranging reference frames according to zooming ratios; and an index assigning unit for assigning reference frame indexes according to the zooming ratios of the reference frame.

The reference frame is one or more of non-zoomed frame, zoomed-in frame, and zoomed-out frame.

When motion vector is estimated in the reference frame, the motion vector may be encoded by using different codebooks according to the zooming ratios of the reference frame.

According to a third embodiment of the present disclosure, an apparatus for configuring and indexing a reference image for estimating motion vector includes: a reference image configuring unit for warping the reference image and arranging reference frames according to warping method; and an index assigning unit for assigning reference frame indexes according to the warping method of the reference frame.

The reference frame may be one of non-warped frame and warped frame.

When motion vector is estimated in the reference frame, if the reference frame is warped frame, the motion is encoded by estimating warping parameters and motion vector.

According to a fourth embodiment of the present invention, an apparatus for configuring and indexing a reference image for estimating motion vector includes: a reference image configuring unit for performing illumination compensation on the reference image and arranging reference frames according to illumination compensation method and levels; and an index assignment unit for assigning reference frame indexes according to the illumination compensation methods and levels of the reference frame.

The reference frame may be one of illumination uncompensated frame and illumination compensated frame.

When motion vector is estimated in the reference frame, if the reference frame is illumination compensated frame, the motion vector may be estimated with respect to the illumination compensated reference image data.

According to a fifth embodiment of the present invention, an apparatus for configuring and indexing a reference image for estimating motion vector includes: a reference image configuring unit for performing processing combined with two or more of interpolation in a variety of spatial resolutions, zooming in various ratios, warping, and illumination compensation with respect to the reference image, and arranging reference frames according to processing methods and processing levels; and an index assignment unit for assigning reference frame indexes according to the processing method and processing level of the reference frame.

In the apparatus for configuring and indexing the reference image according to the first embodiment, a method for configuring and indexing a reference image for estimating motion vector includes: processing the reference image in a variety of arbitrary different methods and arranging reference frames according to processing methods; and assigning reference frame indexes according to the processing methods.

In the apparatus for configuring and indexing the reference image according to the second embodiment, a method for configuring and indexing a reference image for estimating motion vector includes: interpolating the reference image in a variety of spatial resolutions and arranging reference frames according to the spatial resolutions; and assigning reference frame indexes according to the spatial resolution of the reference frame.

In the apparatus for configuring and indexing the reference image according to the third embodiment, a method for configuring and indexing a reference image for estimating motion vector includes: zooming the reference image in a variety of ratios and arranging reference frames according to zooming ratios; and assigning reference frame indexes according to the zooming ratios of the reference frame.

In the apparatus for configuring and indexing the reference image according to the fourth embodiment, a method for configuring and indexing a reference image for estimating motion vector includes: warping the reference image and arranging reference frames according to warping method; and assigning reference frame indexes according to the warping method of the reference frame.

In the apparatus for configuring and indexing the reference image according to the fifth embodiment, a method for configuring and indexing a reference image for estimating motion vector includes: processing illumination compensation on the reference image and arranging reference frames according to illumination compensation method and levels; and assigning reference frame indexes according to the illumination compensation methods and levels of the reference frame.

In addition, with a reference image indexing technique according to the present disclosure, forward and backward reference images may be referenced by continuous index numbers requiring no separate flags to be used to distinctively indicate the reference images.

The method of configuring the reference image described in the foregoing embodiments and detailed description may be delivered to a decoder by using separate information, when a sequence header or picture header or slice header may be used for delivering the information. Further, in the event of configuring the reference image between the encoder and decoder in an agreed method, no separate information is necessary for the decoder to configure the reference image into its decoding operation.

### Advantageous Effects

According to the present disclosure as described above, a reference image is interpolated in a variety of spatial resolutions, or reference image is processed through illumination compensation, zoom-in and zoom-out, warping and the like so as to assign the index of reference frame according to the processing method. Therefore, the coding efficiency of motion vector may be improved.

### DESCRIPTION OF DRAWINGS

FIG. 1 shows an example of MV search when a plurality of reference images are used;

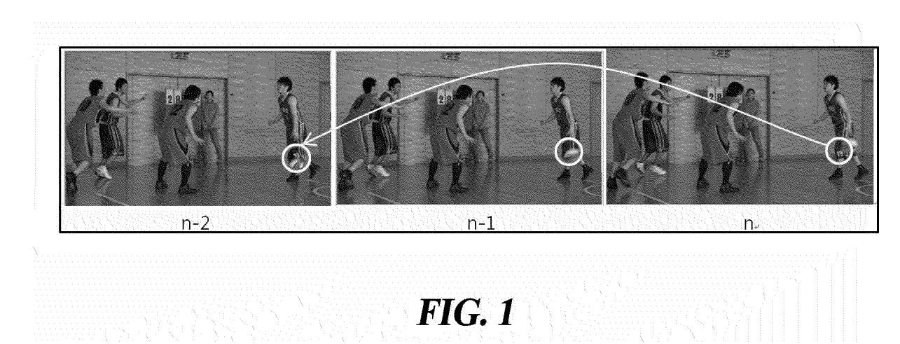

FIG. 2 is a diagram showing an example of reference frame index assignment when past frames are used as reference images;

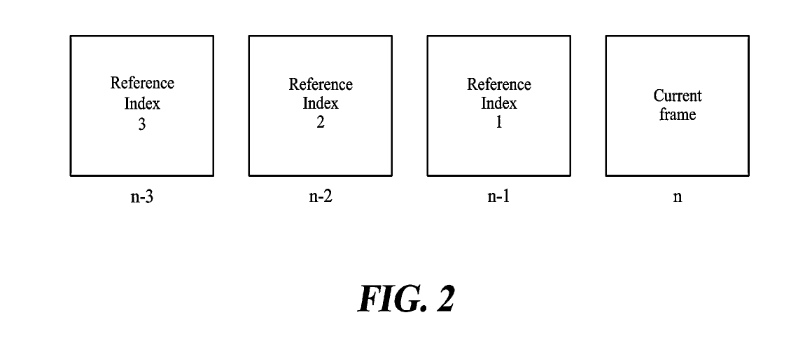

FIG. 3 is a diagram showing an example of reference frame index assignment when past and future frames are used as reference images;

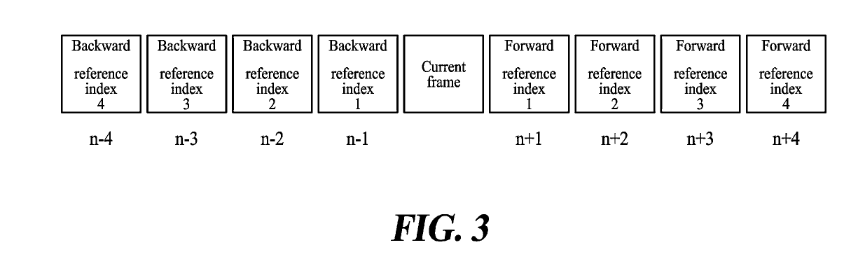

FIG. 4 is a diagram schematically showing an apparatus for configuring and indexing a reference image according to one or more embodiment of the present disclosure;

FIG. 5 is a flowchart showing a method for configuring and indexing a reference image by the apparatus of FIG. 4;

FIG. 6 is a diagram showing an example of reference frame index assignment according to spatial resolutions of a reference frame;

FIG. 7 is a diagram showing another example of reference frame index assignment according to spatial resolution of a reference frame;

FIG. 8 is a diagram showing an example of reference frame index assignment according to zoom-in/zoom-out of a reference frame;

FIG. 9 is a diagram showing another example of reference frame index assignment according to zoom-in/zoom-out of a reference frame;

FIG. 10 is a diagram showing an example of reference frame index assignment according to warping methods of a reference frame;

FIG. 11 is a diagram showing another example of reference frame index assignment according to warping methods of a reference frame;

FIG. 12 is a diagram showing an example of reference frame index assignment according to illumination compensation of a reference frame;

FIG. 13 is a diagram showing another example of reference frame index assignment according to illumination compensation of a reference frame;

FIG. 14 is a diagram showing an example of bi-directional prediction of the reference image frame in which forward and backward reference images are indexed in continuous numbers without the use of any other flags as for information on the directions; and

FIG. 15 is a diagram showing another example of bi-directional prediction of the reference image frame in which forward and backward reference images are indexed in continuous numbers without the use of any other flags as for information on the directions.

### DETAILED DESCRIPTION

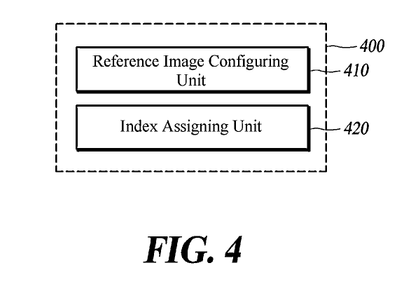

FIG. 4 is a diagram schematically showing an apparatus for configuring and indexing a reference image according to one or more embodiment of the present disclosure. Referring to FIG. 4, the apparatus 400 for configuring and indexing a reference image may include a reference image configuring unit 410 and an index assignment unit 420. The apparatus 400 for configuring and indexing a reference image may be included as an element separate from an inter predictor within a video encoding apparatus, or may be implemented as an additional function of an inter predictor within a video encoding apparatus. The apparatus 400 for configuring and indexing a reference image configures and indexes a reference image so as to estimate motion vector.

The reference image configuring unit 410 arranges reference frames according to a variety of spatial resolutions by performing interpolation on a reference image in the spatial resolutions. Alternatively, the reference image configuring unit 410 may arrange reference frames according to zooming ratios by performing zooming on a reference image in a variety of ratios. Alternatively, the reference image configuring unit 410 may arrange reference frames according to warping methods by performing warping on a reference image. Alternatively, the reference image configuring unit 410 may arrange reference frames according to illumination compensation and level by performing illumination compensation on a reference image.

The index assignment unit 420 assigns reference frame indexes according to processing methods and processing levels of reference frames arranged by the reference image configuring unit 410.

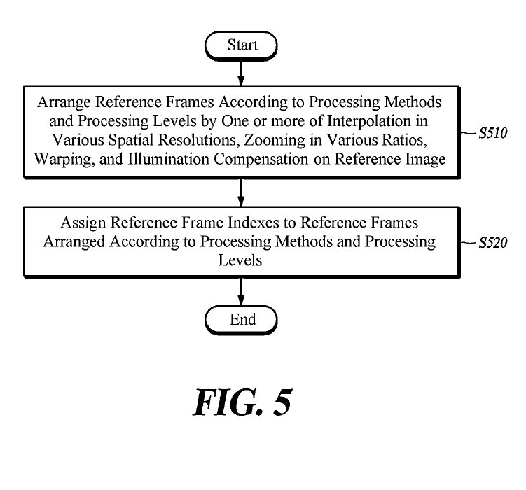

FIG. 5 is a flowchart showing a method for configuring and indexing a reference image by the apparatus of FIG. 4. The function and operation of the apparatus for configuring and indexing a reference image according to an embodiment of the present disclosure will be described with reference to the accompanying drawings.

The reference image configuring unit 410 arranges reference frames according to processing methods and processing levels by performing one or more of interpolation in a variety of spatial resolutions, zooming in various ratios, warping, and illumination compensation with respect to the reference image (S510).

The index assignment unit 420 assigns reference frame indexes to the arranged reference frames according to processing methods and degrees by the reference image configuring unit 410 (S520).

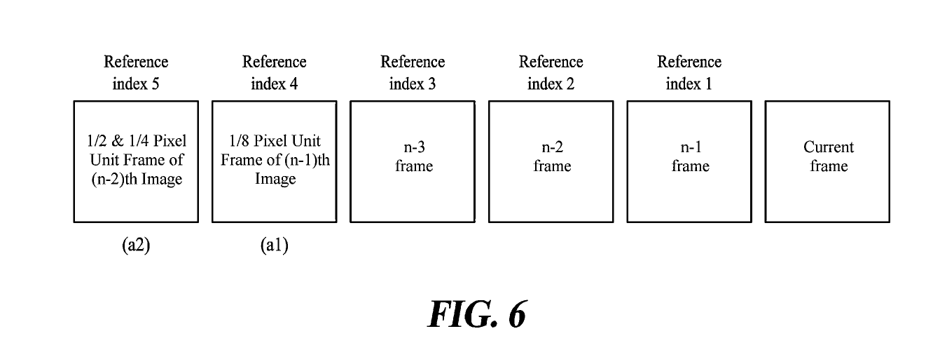

FIG. 6 is a diagram showing an example of reference frame index assignment according to spatial resolutions of the reference frame.

In FIG. 6, ‘n−1 frame’ refers to a past (n−1)th frame that is not processed. In addition, ‘½ pixel unit frame’, ‘¼ pixel unit frame’, and ‘⅛ pixel unit frame’ refer to a reference image that is generated by interpolating an existing reference image and selecting and storing only information of ½ pixel unit, ¼ pixel unit, and ⅛ pixel unit. For example, “⅛ pixel unit frame of an (n−1)th image” is a reference image that is generated by interpolating an (n−1)th reference image and storing only a signal value of ⅛ pixel unit. In addition, “½ & ¼ pixel unit frame of an (n−2)th image” is a reference image that is generated by interpolating an (n−2)th reference image and storing only signal values of ½ pixel unit and ¼ pixel unit. The reference frame indexes of FIG. 6 may be encoded by using Table 1.

When the reference image is configured by using the method of FIG. 6, a method of encoding motion vector for coding block of current frame is as follows. When the motion vector of the current coding block is estimated from frames of reference indexes 1, 2 and 3, the motion vector is estimated by using a codebook considering all of integer pixel unit, ½ pixel unit, and ¼ pixel unit, and when the motion vector is estimated from a frame a1, the motion vector is estimated by using only ⅛ pixel unit. When the motion vector is estimated from only a frame a2, the motion vector is estimated by using only ½ pixel unit and ¼ pixel unit. The codebook used for encoding the motion vector in each frame is individually designed therefor. In the frames of the reference indexes 1, 2 and 3, a codebook is used considering the motion vectors of all resolutions, including ‘integer’, ½′, ‘¼’, and ‘⅛’, as shown in Table 4 below.

TABLE 4

| Differential Motion Vector | Code Number | Bit String |
|---|---|---|
| 0 | 0 | 0 |
| 1/8 | 1 | 010 |
| −1/8 | 2 | 011 |
| 2/8 | 3 | 00101 |
| −2/8 | 4 | 00110 |
| 3/8 | 5 | 00111 |
| −3/8 | 6 | 0001000 |
| 4/8 | 7 | 0001001 |
| −4/8 | 8 | 0001010 |
| 5/8 | 9 | . . . |

When the motion vector estimated in the reference frame a1 is encoded, a codebook for encoding only the motion vector of ⅛ pixel unit is used as shown in Table 5.

TABLE 5

| Differential Motion Vector | Code Number | Bit String |
|---|---|---|
| 0 | 0 | 0 |
| 1/8 | 1 | 010 |
| −1/8 | 2 | 011 |
| 3/8 | 3 | 00101 |
| −3/8 | 4 | 00110 |
| 5/8 | 5 | 00111 |
| −5/8 | 6 | 0001000 |
| 7/8 | 7 | 0001001 |
| −7/8 | 8 | 0001010 |
| 9/8 | 9 | . . . |

In addition, when encoding the motion vector found in the reference frame a2, a codebook for encoding motion vectors of only ½ pixel unit and ¼ pixel unit is used as shown in Table 6 below.

TABLE 6

| Differential Motion Vector | Code Number | Bit String |
|---|---|---|
| 0 | 0 | 0 |
| 1/4 | 1 | 010 |
| −1/4 | 2 | 011 |
| 1/2 | 3 | 00101 |
| −1/2 | 4 | 00110 |
| 3/4 | 5 | 00111 |
| −3/4 | 6 | 0001000 |
| 5/4 | 7 | 0001001 |
| −5/4 | 8 | 0001010 |
| 6/4 | . . . | . . . |

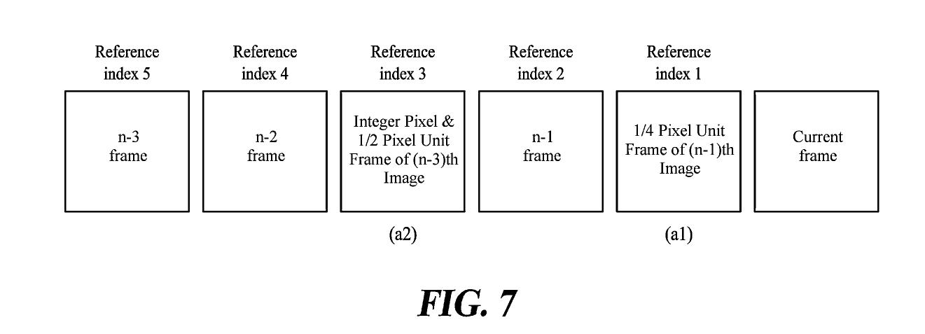

Tables 4 to 6 are merely exemplary codebooks for representation of motion vectors according to resolution information, and the embodiment of the present disclosure does not limit the method of representing the motion vectors. In addition, FIG. 6 and Tables 4 to 6 described above are merely illustrative of the present disclosure, and do not limit the type of spatial resolution signals for each reference frame position (each reference index number). That is, another embodiment of the present disclosure may be implemented as shown in FIG. 7, and this embodiment also is merely exemplary and does not limit the present disclosure. This embodiment of the present disclosure may be used for bi-direction motion estimation.

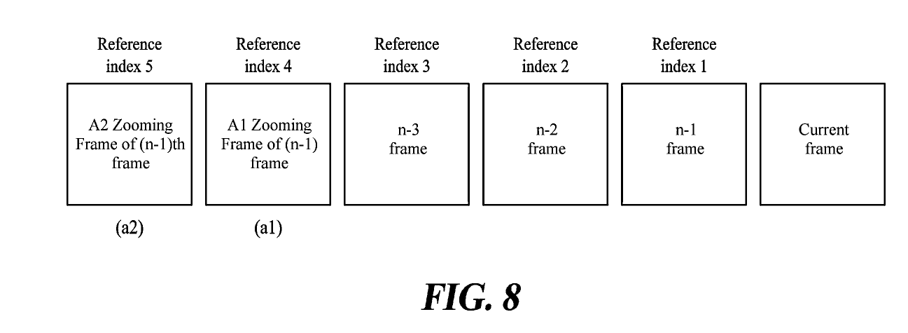

FIG. 8 is a diagram showing an example of reference frame index assignment according to zoom-in/zoom-out of a reference frame. In FIG. 8, n−1, n−2, and n−3 frames refer to the existing (n−1)th, (n−2)th and (n−3)th reference frames to which no process is performed. ‘A1 zooming frame of (n−1)th frame’ is an image generated by Al-zooming (n−1)th reference image. In this case, when the value of A1 is greater than 1 (that is, A1>1), the image is a zoom-in image, and when the value of A1 is less than 1 (that is, A1<1), the image is a zoom-out image. In the embodiment of the present disclosure, there is no limitation to a zoom-in or zoom-out method. The reference frame indexes of FIG. 8 are encoded by using Table 1 above.

When the reference image is configured by using the method of FIG. 8, a method of encoding motion vector for coding block of current frame is as follows. In the frames of reference indexes 1, 2 and 3 for the motion vector of current coding block, the motion vector considering all of integer pixel unit, ½ pixel unit, ¼ pixel unit, and ⅛ pixel unit (up to a defined arbitrary resolution) is estimated. In the frame a1, the motion vector for Al-zoomed image data is estimated. In the frame a2, the motion vector for A2-zoomed image data is estimated.

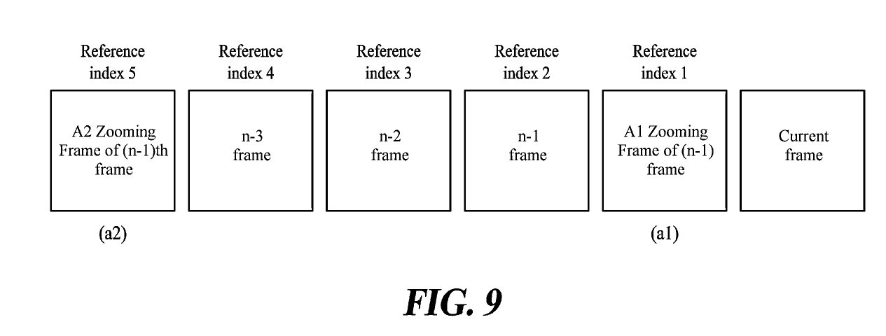

FIG. 8 illustrates an embodiment of the present disclosure, and the type of zoom-in/zoom-out signals for each reference frame position is not limited. That is, the embodiment of the present disclosure includes images which are generated by zooming in and zooming out a reference image in various ratios, as reference images in a reference image list. Another embodiment of the present disclosure may be provided as shown in FIG. 9, and FIG. 9 also is merely exemplary and does not limit the present disclosure. In addition, the embodiments of the present disclosure may be used for bi-direction motion estimation.

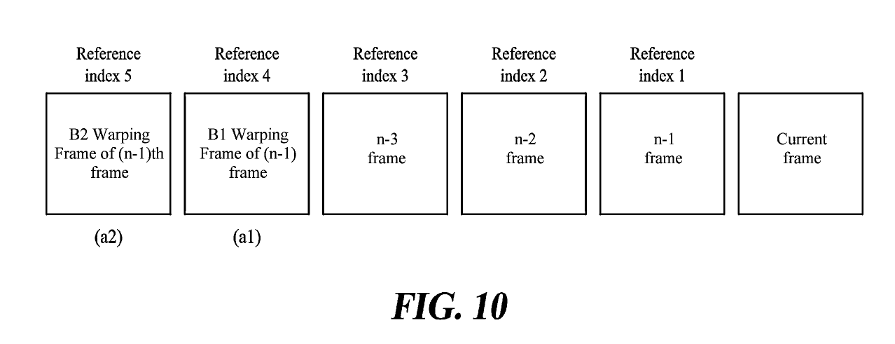

FIG. 10 is a diagram showing an example of reference frame index assignment according to warping methods of a reference frame. In FIG. 10, n−1, n−2, and n−3 frames refer to the existing (n−1)th, (n−2)th and (n−3)th reference frames to which no process is performed. ‘B1 warping frame of (n−1)th frame’ is an image generated by performing B1 method of warping on (n−1)th reference image. Examples of warping method include a method of changing a pixel value and a block shape through linear transform and equilibrium shift process, but there is no limitation of warping methods in the embodiment of the present disclosure. The reference frame indexes of FIG. 10 may be encoded by using Table 1 above.

When the reference image is configured by using the method of FIG. 10, a method of encoding motion vector for coding block of current frame is as follows. In the frames of reference indexes 1, 2 and 3 for motion vector of current coding block, an estimation is performed on the motion vector considering all of integer pixel unit, ½ pixel unit, ¼ pixel unit, and ⅛ pixel unit (up to a defined arbitrary resolution). In the frame a1, the motion vector estimation is performed with respect to image data processed by using the B1 warping method. In the frame a2, the motion vector for image data processed by using B2-warping method is estimated.

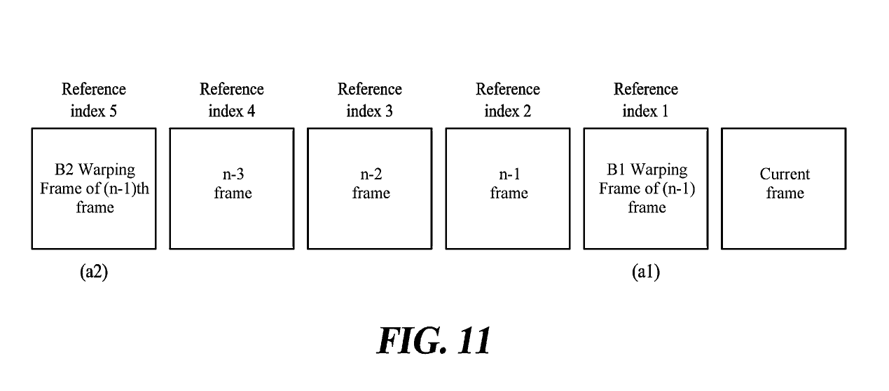

FIG. 10 illustrates an embodiment of the present disclosure wherein the type of warping methods for each reference frame position is not limited. That is, the method proposed by the embodiment of the present disclosure to include images which are generated by warping a reference image in various methods, as reference images in a reference image list. Another embodiment of the present disclosure may be provided as shown in FIG. 11, which is merely exemplary and does not limit the present disclosure. In addition, the embodiments of the present disclosure may be used for bi-direction motion estimation.

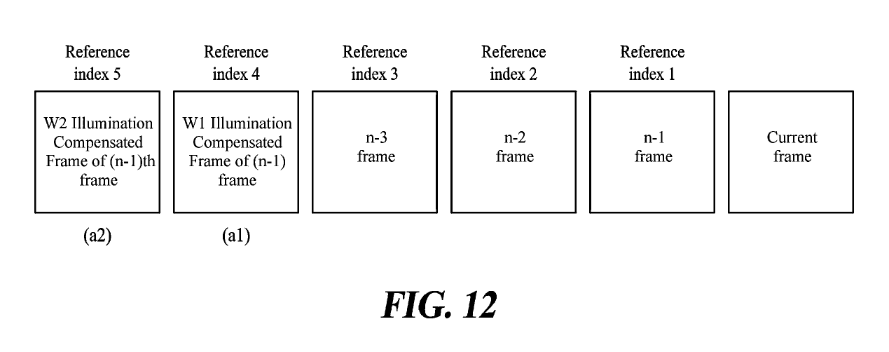

FIG. 12 is a diagram showing an example of reference frame index assignment according to temporal position and illumination compensation of a reference frame. In FIG. 12, n−1, n−2, and n−3 frames refer to the existing (n−1)th, (n−2)th and (n−3)th reference frames to which no process is performed. ‘W1 illumination compensated frame of n−1 frame” is an image that is generated by performing illumination compensation on (n−1)th reference image through a W1 method. Examples of the illumination compensation method include a method of giving a gain by changing an illuminance ratio, and a method of offsetting illumination. However, in the embodiment of the present disclosure, there is no limitation to the method of compensating illumination. The reference frame indexes of FIG. 12 may be encoded by using Table 1.

When the reference image is configured by using the method of FIG. 12, a method of encoding motion vector for coding block of current frame is as follows. In the frames of reference indexes 1, 2 and 3 for motion vector of current coding block, an estimation is performed on the motion vector considering all of integer pixel unit, ½ pixel unit, ¼ pixel unit, and ⅛ pixel unit (up to a defined arbitrary resolution). In the frame a1, the motion vector for image data processed by using W1 illumination compensation is estimated. In the frame a2, the motion vector for image data processed by using W2 illumination compensation is estimated.

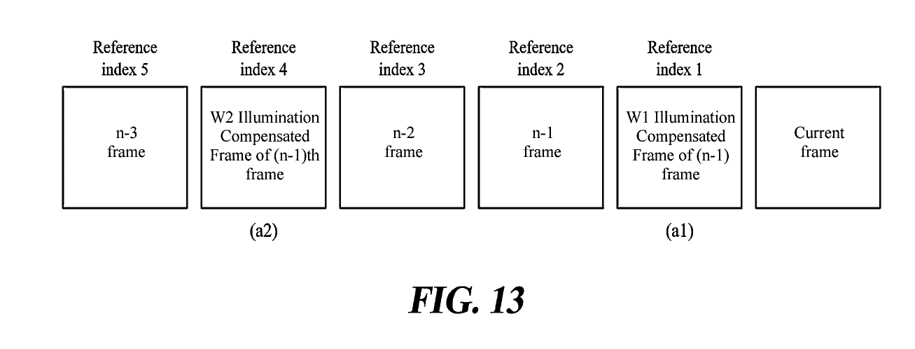

FIG. 12 illustrates an embodiment of the present disclosure wherein the type of illumination compensation methods for each reference frame position is not limited. That is, the method proposed by the embodiment of the present disclosure is to include images which are generated by performing illumination compensation on a reference image in various methods, as reference images in a reference image list. Another embodiment of the present disclosure may be provided as shown in FIG. 13 which is merely exemplary and does not limit the present disclosure. In addition, the embodiments of the present disclosure may be used for bi-direction motion estimation.

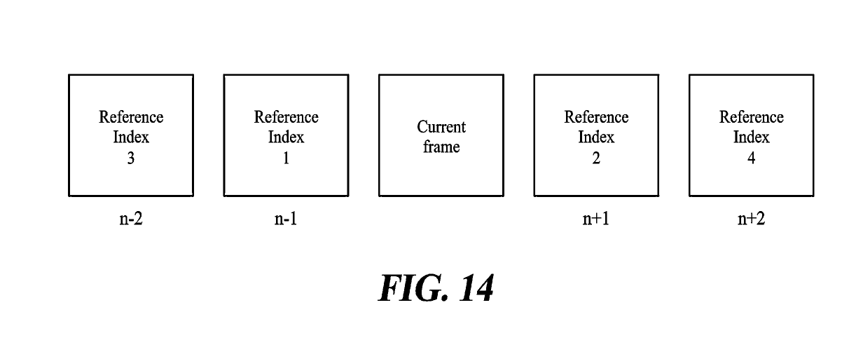

FIG. 14 is a diagram showing an example of continuous index numbers indicating past and future reference images in performing bidirectional prediction of reference frames without needing a separate flag bit to display directional information. FIG. 14 illustrates that reference frames n−1, n+1 that are close in time have small index numbers assigned while reference frames n−2, n+2 which are more distanced temporally get larger index numbers assigned.

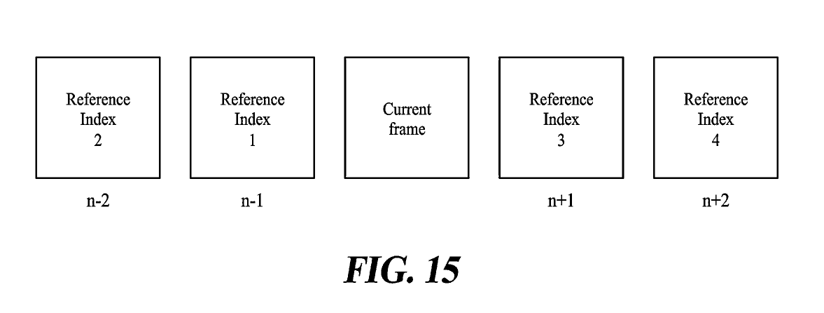

FIG. 14 shows an embodiment of the present invention and does not restrict the type of method for allocating the reference frame index in bidirectional prediction. That is, one of the methods proposed by the embodiments of the present disclosure is to assign low indices to reference images in temporally closer proximity. For example, this can be also expressed by FIG. 15 which is just illustrative of the present invention without limiting the present disclosure.

In the embodiments described above, the description has been given of the case where a specific reference image is used as additional reference images through ‘resolution conversion, ‘zooming’, ‘warping’, and ‘illumination conversion’. However, the present technology is not limited to the reference image conversion using the four methods, and a variety of additional conversion methods may also be used for accurately obtaining motion vector.

In addition, a decoder of the present disclosure may have an advance agreement of the method of configuring specific reference image with an encoder, and the encoder may provide the decoder with additional information on the method of configuring the reference image. There is no restriction to the method of coding the information to be delivered to the decoder.

Also, the technologies proposed in the embodiments of the present disclosure do not limit the combined use of images, modified by one or more methods, as reference images in the list of reference images. For example, among the reference images, ‘unmodified past reference image’, ‘illumination compensated reference image’, ‘warped reference image’, ‘zoomed reference image’, ‘reference image composed of only specific resolution information’, and ‘reference image modified by addition processes’ can be used together. In this case, the method of assigning indexes to the respective processed images is not limited to the embodiments of the present disclosure.

Using Table 1 for encoding the reference frame index in the above description of the present disclosure is merely exemplary, and there is no limitation to the method of encoding reference frame index.

Although exemplary aspects of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes. Accordingly, the scope of the disclosure is not to be limited by the above aspects but by the claims and the equivalents thereof.

### INDUSTRIAL APPLICABILITY

As described above, the present disclosure is highly useful for application in the fields of reference image configuration and indexing. A reference image is interpolated in various spatial resolutions, or a reference image is variously configured by performing zooming in and out at various magnifications, warping, illumination compensation, and the like, and reference frame indexes are assigned according to the processing methods and processing levels, thereby improving the coding efficiency of motion vector.

### CROSS-REFERENCE TO RELATED APPLICATION

If applicable, this application claims priorities under 35 U.S.C §119(a) of Patent Application No. 10-2010-0046178, filed on May 17, 2010 and Patent Application No. 10-2011-0045528, filed on May 16, 2011 in Korea, the entire contents of which are incorporated herein by reference. In addition, this non-provisional application claims priorities in countries, other than the U.S., with the same reason based on the Korean Patent Applications, the entire contents of which are hereby incorporated by reference.

1. An apparatus for configuring and indexing a reference image for estimating motion vector, comprising:
a reference image configuring unit for processing the reference image in a variety of arbitrary different methods and arranging reference frames according to processing methods; and
an index assignment unit for assigning reference frame indexes according to the method processed by the reference image configuring unit.

2. The apparatus of claim 1, wherein when motion vector estimated in the reference frame is encoded, the motion vector is encoded by using different codebooks according to the method processed by the reference image configuring unit.

3. An apparatus for configuring and indexing a reference image for estimating motion vector, comprising:
a reference image configuring unit for interpolating the reference image in a variety of spatial resolutions and arranging reference frames according to the spatial resolutions; and
an index assignment unit for assigning reference frame indexes according to the spatial resolution of the reference frame.

4. The apparatus of claim 3, wherein the reference frame is one or more of non-interpolated frame, ½ pixel unit frame, ¼ pixel unit frame, ⅛ pixel unit frame, and frame combined with two or more of ½ pixel unit, ¼ pixel unit, and ⅛ pixel unit.

5. The apparatus of claim 3, wherein when motion vector estimated in the reference frame is encoded, the motion vector is encoded by using different codebooks according to the spatial resolution of the reference frame.

6. An apparatus for configuring and indexing a reference image for estimating motion vector, comprising:
a reference image configuring unit for zooming the reference image in a variety of ratios and arranging reference frames according to zooming ratios; and
an index assigning unit for assigning reference frame indexes according to the zooming ratios of the reference frame.

7. The apparatus of claim 6, wherein the reference frame is one or more of non-zoomed frame, zoomed-in frame, and zoomed-out frame.

8. The apparatus of claim 6, wherein when motion vector estimated in the reference frame is encoded, the motion vector is encoded by using different codebooks according to the zooming ratios of the reference frame.

9. An apparatus for configuring and indexing a reference image for estimating motion vector, comprising:
a reference image configuring unit for warping the reference image and arranging reference frames according to warping method; and
an index assigning unit for assigning reference frame indexes according to the warping method of the reference frame.

10. The apparatus of claim 9, wherein the reference frame is one of non-warped frame and warped frame.

11. The apparatus of claim 9, wherein when motion vector estimated in the reference frame is encoded, the motion vector is encoded by using different codebooks according to the warping method of the reference frame.

12. An apparatus for configuring and indexing a reference image for estimating motion vector, comprising:
a reference image configuring unit for performing illumination compensation on the reference image and arranging reference frames according to illumination compensation method and levels; and
an index assignment unit for assigning reference frame indexes according to the illumination compensation methods and levels of the reference frame.

13. The apparatus of claim 12, wherein the reference frame is one of illumination uncompensated frame and illumination compensated frame.

14. The apparatus of claim 12, wherein when motion vector estimated in the reference frame is encoded, the motion vector is encoded by using different codebooks according to the illumination compensated and level of the reference frame.

15. An apparatus for configuring and indexing a reference image for estimating motion vector, comprising:
a reference image configuring unit for performing processing combined with two or more of interpolation in a variety of spatial resolutions, zooming in various ratios, warping, and illumination compensation with respect to the reference image, and arranging reference frames according to processing methods and processing levels; and
an index assignment unit for assigning reference frame indexes according to the processing method and processing level of the reference frame.

16. An apparatus for configuring and indexing a reference image for estimating motion vector, comprising:
a reference image configuring unit for arranging reference frames in bidirectionally predicting the reference image, according to temporal locations and temporal variations; and
an index assignment unit for assigning reference frame indexes freely in bidirectionally predicting the reference image according to temporal locations and temporal variations.

17. The apparatus of claim 16, wherein the index assignment unit performs indexing the reference frames on one hand and encoding directional information of the reference frames on the other hand.

18. The apparatus of claim 16, which encodes information of a method of configuring the reference frames.

19. The apparatus of claim 16, wherein the index assignment unit assigns lower indexes to temporally closer reference images.

20. A method for configuring and indexing a reference image for estimating motion vector, comprising:
processing the reference image in a variety of arbitrary different methods and arranging reference frames according to processing methods; and
assigning reference frame indexes according to the processing methods.

21. The method of claim 20, wherein when motion vector estimated in the reference frame is encoded, the motion vector is encoded by using different codebooks according to the processing methods.

22. A method for configuring and indexing a reference image for estimating motion vector, comprising:
interpolating the reference image in a variety of spatial resolutions and arranging reference frames according to the spatial resolutions; and
assigning reference frame indexes according to the spatial resolution of the reference frame.

23. The method of claim 22, wherein the reference frame is one or more of non-interpolated frame, ½ pixel unit frame, ¼ pixel unit frame, ⅛ pixel unit frame, and frame combined with two or more of ½ pixel unit, ¼ pixel unit, and ⅛ pixel unit.

24. The method of claim 22, wherein when motion vector estimated in the reference frame is encoded, the motion vector is encoded by using different codebooks according to the spatial resolution of the reference frame.

25. A method for configuring and indexing a reference image for estimating motion vector, comprising:
zooming the reference image in a variety of ratios and arranging reference frames according to zooming ratios; and
assigning reference frame indexes according to the zooming ratios of the reference frame.

26. The method of claim 25, wherein the reference frame is one or more of non-zoomed frame, zoomed-in frame, and zoomed-out frame.

27. The method of claim 25, wherein when motion vector estimated in the reference frame is encoded, the motion vector is encoded by using different codebooks according to the zooming ratios of the reference frame.

28. A method for configuring and indexing a reference image for estimating motion vector, comprising:
warping the reference image and arranging reference frames according to warping method; and
assigning reference frame indexes according to the warping method of the reference frame.

29. The method of claim 28, wherein the reference frame is one of non-warped frame and warped frame.

30. The method of claim 28, wherein when motion vector estimated in the reference frame is encoded, the motion vector is encoded by using different codebooks according to the warping method of the reference frame.

31. A method for configuring and indexing a reference image for estimating motion vector, comprising:
processing illumination compensation on the reference image and arranging reference frames according to illumination compensation method and levels; and
assigning reference frame indexes according to the illumination compensation methods and levels of the reference frame.

32. The method of claim 31, wherein the reference frame is one of illumination uncompensated frame and illumination compensated frame.

33. The method of claim 31, wherein when motion vector estimated in the reference frame is encoded, the motion vector is encoded by using different codebooks according to the illumination compensation method and level of the reference frame.

34. A method for configuring and indexing a reference image for estimating motion vector, comprising:
performing processing combined with two or more of interpolation in a variety of spatial resolutions, zooming in various ratios, warping, and illumination compensation with respect to the reference image, arranging reference frames according to processing methods and processing levels; and
assigning reference frame indexes according to the processing methods and processing levels of the reference frame.

35. A method for configuring and indexing a reference image for estimating motion vector, comprising:
arranging reference frames in bidirectionally predicting the reference image according to temporal locations and temporal variations; and
assigning reference frame indexes freely in bidirectionally predicting the reference image, according to temporal locations and temporal variations.

36. The method of claim 35, which performs indexing the reference frames on one hand and encoding directional information of the reference frames on the other hand.

37. The method of claim 35, which encodes information of the method of configuring the reference frames.

38. The method of claim 35, wherein the process of assigning the reference frame indexes assigns lower indexes to temporally closer reference images.
